(19) United States
(12) Patent Application Publication
(10) Pub. No.: US 2008/0190465 A1
(43) Pub. Date: Aug. 14, 2008

(54) One minute car wash

(76) Inventor: David M. Medinis, Ft. Myers, FL (US)

Correspondence Address: EDWIN W. OLDHAM, 400 PARK SHORE DR. # 200, NAPLES, FL, 34103, US

(21) Appl. No.: 11/705,621

(22) Filed: Feb. 14, 2007

(51) Int. Cl. B08B 3/04

(52) U.S. Cl. 134/123

(57) ABSTRACT

The invention relates to a vehicle wash system that operates in a very short period of time; less than one minute, and operates in a mode different than most carwash systems that utilize high pressure and atomization of the water and soap materials, but in this instance the invention operates with no moving parts which includes nozzles that spray water in a non-atomized form in large volume in a short period of time onto the vehicle. Particularly, the invention utilizes approximately 80 pounds per square inch pressure operating through a ½-¼ inch diameter nozzle, and this provides a high volume of water under sufficient pressure to achieve a very excellent cleaning as it is associated with a soap cycle and a rinse cycle. Further, the apparatus requires no moving parts as the car is placed in position in a tunnel with the water-carrying beams defining the tunnel and the nozzles being associated with the beams.

### BACKGROUND OF THE INVENTION

Consumers invest millions of dollars each year in vehicles for business and pleasure. Many of these consumers take great pride in maintaining the appearance of their vehicles. Subsequently, manual and automated carwashes, in addition to car washing services, have become very popular in recent years. Only a small percentage of vehicle owners, however, enjoy or can afford spending the time necessary to either wash their vehicles or wait for a service to wash their vehicles.

The typical carwash today incorporates some type of roller mechanism to move the car through the wash, rinse and drying cycles within a long tunnel as the vehicle moves along the wash path. Typically, also, the systems utilize a high pressure low volume atomized amount of water and/or soap to perform the cleaning function.

### SUMMARY OF THE INVENTION

The present invention includes a vehicle washing apparatus that has a vehicle housing and a plurality of tanks located on top of the vehicle housing. The tanks are to provide an amount of water, a pumping capability, and soap and rinse storage as well as collection and storage of the fluids utilized during the washing operation.

A further object of the invention is that the tunnel is formed of a plurality of beams, which are fluid-carrying beams and are all interconnected with each other, and the beams carrying spray nozzles to provide full coverage of the vehicle at all times the pressure is actuated to the system. The system achieves a very high volume of water and there are no moving parts for breakdown.

A further object of the invention is to provide a high volume (not atomized) of water by utilizing a ½-¾ inch nozzle with an approximately a 15° spray pattern and an operational pressure of 80 pounds per square inch.

### BRIEF DESCRIPTION OF THE DRAWINGS

For a more complete understanding of the present invention, including its features and advantages, reference is now made to the detailed description of the drawings taken in conjunction with the accompanying drawings in which like numerals identify like parts and in which:

FIG. 1 is a side elevational view of the apparatus of the invention showing the car in position in the tunnel and the various equipment associated with the washing system;

FIG. 2 is an elevational view taken from the open end of the tunnel, showing the vehicle in position and in which the nozzles are shown in actuated position to fully cover the vehicle at all times;

FIG. 3 is a schematic depiction of the interconnection between the support tubes of the tunnel and showing the complete fluid interrelation between the various tubes comprising the tunnel of the invention; and

FIG. 4 is a schematic showing the nozzle emitting fluid therethrough and indicating the conical spray pattern from the nozzle.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not limit the scope of the invention.

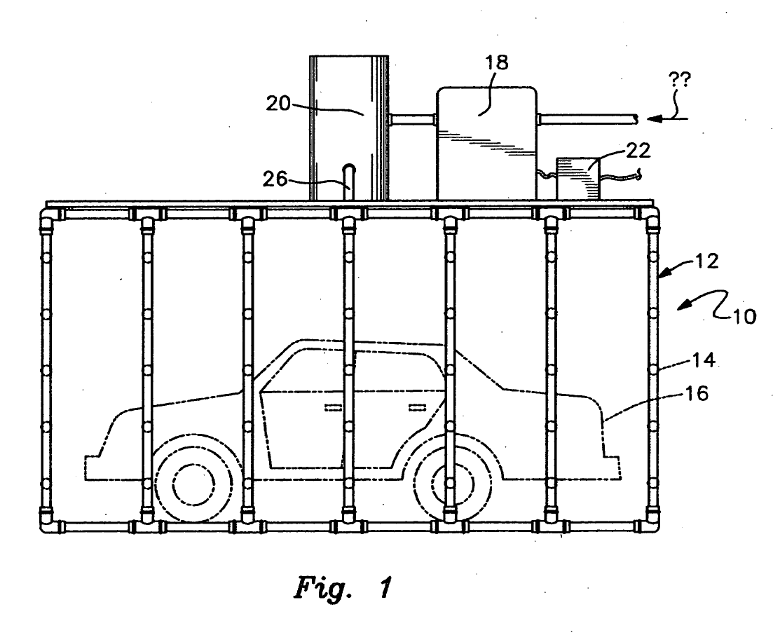

Looking now at FIG. 1 of the drawings, the 10 indicates generally the carwash tunnel that is made up of a plurality of pipes or beams that are generally indicated by 12 and they have a series of nozzles 14 associated with each pipe or beam 12. The vehicle is indicated by 16, and it is positioned so that it is covered throughout its length from the rear bumper to the front bumper in the tunnel 10. The vehicle is either driven into position or moved mechanically into position, but once it is in position and stopped there is no more movement of the vehicle relative to the tunnel 10 and the system operates as will be explained hereinafter.

FIG. 1 also shows a pumping station 18, and a water storage tank 20 and one other miscellanious tank 22, which all provide the necessary soap and rinse normally associated with the car washing system. The arrow 24 indicated the inflow of fluid into the system and the connection occurs from pipe 26 into the pipe and beam manifold tunnel system of pipes or beams 12, as shown in FIG. 1.

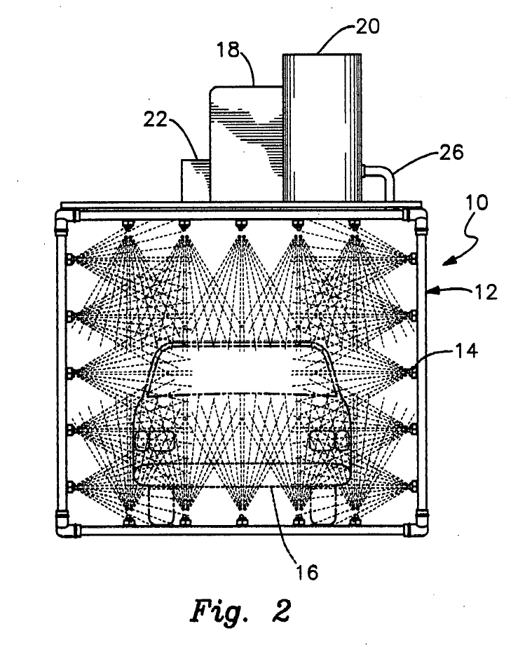

FIG. 2 illustrates the vehicle 16 with the nozzles 14 all showing an actuated spray condition, which shows the complete coverage of all aspects of the vehicle itself.

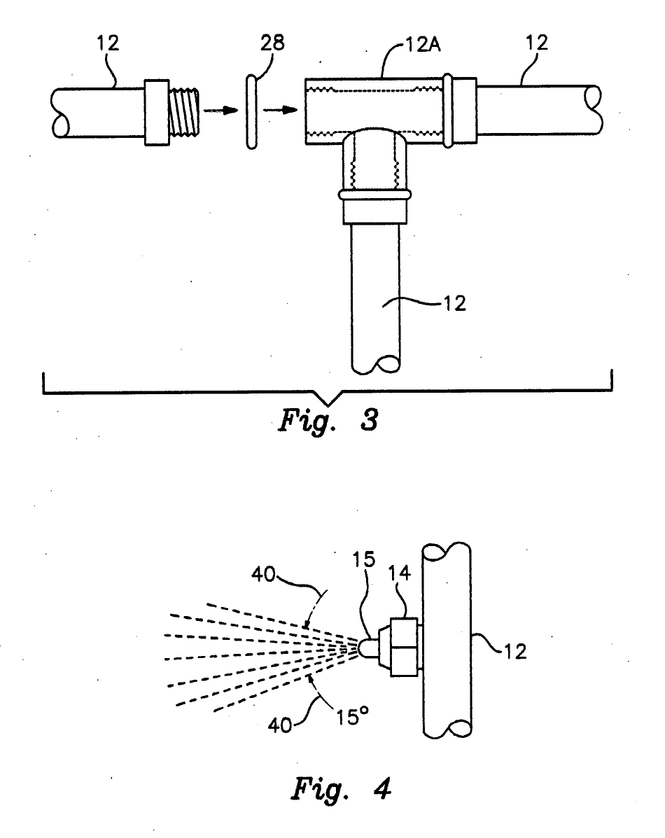

FIG. 3 is a depiction of the pipes or beams 12 showing the interconnection constitutes a threaded screw relationship with a washer, which constitutes a flexible sealing ring 28 between each connection pipe 12 and the joint connector indicated generally by 12A, and it shows, also, of course, that there is a complete fluid flow between each section of pipe 12 and its respective portion into which it is connected. The sealing ring 28 precludes any leakage at the joints.

FIG. 4 illustrates an enlarged view of the nozzle 14, which constitutes a rounded member 15 and essentially shows that the spray pattern occurs around the member 15 and that the spray itself is in a conical angular relationship of approximately 15° and is indicated between the arrows 40.

The pump station 18 is designed to provide an 80 pound per square inch pressure in the piping or beams 12, and this will then operate with a ½ to ¾ inch nozzle 14 to provide a very high volume of water in a very short period of time. The 15° spray pattern lies between the arrows 40 for a total of a 15° spray pattern coverage. The spray pattern is of high volume and not atomized. Use of the nozzles 14 at fixed positions provide for full coverage of the vehicle at all times and this provides more actual wash impact time than previous movable gantry systems. The actual flow of water, soapy water, and/or rincing water is designed to be between about 40 to about 80 gallons per minute, and this contrasts to an average of about 4 gallons per minute for an atomized high pressure washing system. The high volume of water flow provides a major impact on the surfaces of the vehicle, and an excellent cleaning action.

The system is designed to provide an overall wash within one minute, and the water cycle is indicated as follows:
1) wash cycle of 5 seconds—2) apply pre-soak 10 seconds−3) soak, 10 seconds 4)—wash, 5) 10 seconds more presoak, 10 seconds—6) wash, and 7) 10 seconds—spot-free rinse.

Thus, the entire wash cycle is accomplished in less than one minute and it is accomplished with a high volume of water, mixed with soap in the appropriate manner, and then all the water utilized is collected and stored and recycled in the normal manner associated with carwash systems today. The key to the proper operation is the 80 pounds per square inch water pressure and the ½ to ¾ inch nozzle as shown in FIG. 4, and maintaining the 40 to 80 gallons per minute of fluid flow through the nozzles.

Although the invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the dependent claims accomplish any such modifications

What is claimed is:

1. A vehicle wash system that comprises: a plurality of water-carrying beams arranged such that together they provide a tunnel having a height, width and length to fully cover the length, width and height of such vehicle, each beam further being interconnected for water flow to every other beam,
a plurality of operating spray nozzles associated with each beam, and arranged to provide a combined spray effect to fully immerse the vehicle in fluid spray
means to provide fluid under pressure into the beams, causing the nozzles to emit a conical spray pattern of such fluid,
means to vary the fluid between soapy water, spot-free rinse, and water.

2. A vehicle wash system according to claim 1 wherein the nozzles are ½″ to ¾ inch diameter and they, and that the fluid provided to the nozzles through the beam system is at 80 pounds per square inch.

3. A vehicle wash system according to claim 1 wherein the wash cycle is set at a five-second applied pre-soak, a ten-second soak, a ten second wash, a ten-seconds more pre-soak, a ten-second wash, and a ten-second spot-free rinse.

4. A vehicle wash system according to claim 1 wherein there is no relative movement between the vehicle and the tunnel formed by the beams during the wash cycle.

5. A vehicle wash system according to claim 1 where the fluid flow through the nozzles is between 40 to 80 gallons per minute.
